(19) United States
(12) Patent Application Publication
(10) Pub. No.: US 2008/0238856 A1
(43) Pub. Date: Oct. 2, 2008

(54) USING SPATIAL DISTRIBUTION OF PIXEL VALUES WHEN DETERMINING ADJUSTMENTS TO BE MADE TO IMAGE LUMINANCE AND BACKLIGHT

(76) Inventors: Achintva Bhowmik, Milpitas, CA (US); Maximino Vasquez, Fremont, CA (US); Yanli S. Zhang, San Jose, CA (US); Kristine Karnos, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/693,272

(22) Filed: Mar. 29, 2007

(51) Int. Cl. G09G 3/36

(52) U.S. Cl. 345/102

(57) ABSTRACT

A method of adjusting the display of data oh a flat panel display may include ascertaining color value information and spatial distribution information for pixels in an image. A desired image adjustment and a desired backlight adjustment may be determined based on both the color value information and spatial distribution information. The method may also include adjusting color values of at least some pixels in the image based on the desired image adjustment and controlling a backlight intensity based on the desired backlight adjustment.

### CROSS-REFERENCE TO RELATED APPLICATIONS

The present application is related, in various respects, to: U.S. application Ser. No. 10/367,070, filed Feb. 14, 2003 (attorney docket no. P16034); U.S. application Ser. No. 10/663,316, filed Sep. 15, 2003 (attorney docket no, P17654); U.S. application Ser. No. 10/664,013, filed Sep. 15, 2003 (attorney docket no. P17653); U.S. application Ser. No. 10/674,363, filed Sep. 29, 2003 (attorney docket no. P17696); and U.S. application Ser. No. 10/882,446, filed Jun. 30, 2004 (attorney docket no. P19598), the entire contents of these five applications being incorporated by reference herein.

### BACKGROUND

Implementations of the claimed invention generally may relate to the field of electronic displays, and in particular to liquid crystal display (LCD) panel power management through brightness control.

Various types of mobile devices employ LCD panels or other types of panels that employ backlights. One type of such mobile devices, notebook (also called laptop) computers, are lightweight personal computers, which are quickly gaining popularity. The popularity of the notebook computers has especially increased since their prices have been dropping steadily, while maintaining similar performance as their larger siblings (i.e., desktop computers or workstations). The lighter weight restrictions require the mobile platform manufacturers to produce images that compete with the desktop models, while maintaining an increased battery life. Similar power and performance considerations are present in other mobile devices with displays, such as handheld devices (e.g., portable digital assistants (PDAs)), portable media players (e.g., for music, video, text, etc.), portable communication devices (e.g., cell phones or other multifunction devices), although this is not an exhaustive list.

As more functionality is integrated within mobile computing platforms, the need to reduce power consumption becomes increasingly important. Furthermore, users expect increasingly longer battery life in mobile computing platforms, furthering the need for creative power conservation solutions. Mobile computer designers have responded by implementing power management solutions such as, reducing processor and chipset clock speeds, intermittently disabling unused components, and reducing power required by display devices, such as an LCD or “flat panel” display.

Generally, power consumption in flat-panel display monitors increases with flat panel display backlight brightness. In some computer systems, flat panel display backlight power consumption can soar as high as six watts when the backlight is at maximum luminance. In a mobile system, this can significantly shorten battery life. In order to reduce flat panel power consumption and thereby increase battery life, mobile computing system designers have designed power management systems to reduce the flat-panel display backlight brightness while the system is in battery-powered mode.

In reducing backlight brightness in a flat panel display, however, the user may be left with a display image that is of lower quality than when the mobile computing platform is operating on alternating current (AC) power. This reduction in image quality may result from a reduction in color and/or brightness contrast when backlight brightness is reduced.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention, in the drawings,

FIG. 1 illustrates an example mobile system according to some implementations;

FIG. 2 conceptually illustrates the functionality of a portion of the mobile system of FIG. 1;

FIG. 3 illustrates a method of controlling image brightness and a backlight for a flat-panel display; and

FIGS. 4A and 4B respectively illustrate correlation functions for two different images.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

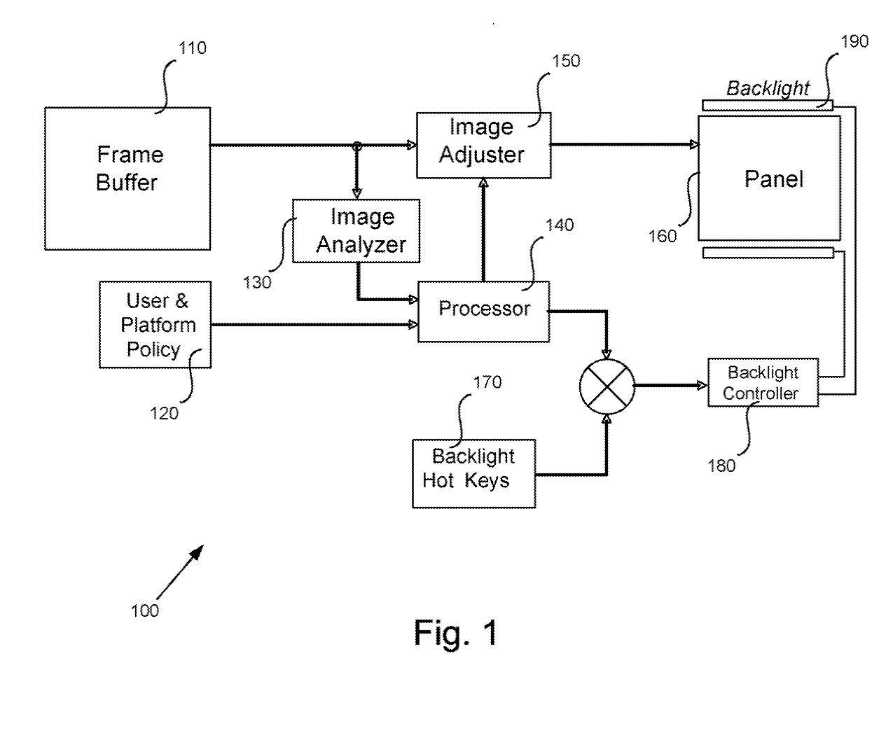

FIG. 1 is a diagram illustrating an example of a mobile system 100 in accordance with one implementation consistent with the principles of the invention. System 100 may include frame buffer 110, policy module 120, image analyzer 130, processor 140, image adjuster 150, display panel 160, backlight hot keys 170, backlight controller 180, and backlight 190. System 100 may also include other components incident to its operation as a mobile system, such as a battery, communication interface(s), antenna(s), input device(s), output port(s) other than a display, etc. Although such additional components are not explicitly shown in FIG. 1 for ease and brevity of description, they may nonetheless be present in mobile system 100.

Frame buffer 110 may be arranged to temporarily store display data. Such display data may be formatted in a certain color space (e.g., red/green/blue (RGB) or luminance/chrominance (YUV), or any other known and used color space).

Policy module 120 may provide an input to processor 140 that reflects the user and/or the platform policy on backlight dimming. Such input may reflect, for example, a user's energy-savings preference, possibly including display dimming after a certain time. Such input from module 120 may also include, in some implementations, platform or system-based adjustments to the backlight and/or panel colors (e.g., gamma preferences or settings, ambient-light based information, etc.). Policy module 120 may provide a “baseline” against which further adjustments may be made based on the color and spatial content of the image in buffer 110, as will be explained further herein.

Image analyzer 130 may be arranged to analyze, for example, a frame of display data from buffer 110 on a pixel-by-pixel basis for certain characteristics (e.g., amplitude information and spatial information). In some implementations, analyzer 130 may analyze all sub-pixels for a given pixel, but in some implementations, analyzer 130 may analyze less than all sub-pixels for a given pixel (e.g., the one or two sub-pixels with the greatest amplitude per pixel). Similarly, in some implementations, analyzer 130 may analyze all pixels within a given image or frame, but in some implementations, analyzer 130 may analyze less than all of the pixels for a given image or frame (e.g., perhaps every other pixel or enough pixels to represent the image to a desired degree of fidelity).

In general, image analyzer 130 may, with or without gamma adjustment of the incoming data, generate information about 1) the amplitudes (e.g., color values or luminosity) of (sub) pixels within an image or frame, and 2) the degree of spatial “spread” of (sub) pixels of a certain color within an image or frame. These two classes of information generated by analyzer 130 may be referred to in shorthand as color information and spatial information. In some implementations, the color information may take the form of a histogram (or similar binned representation of color amplitude) of numbers of pixels verses a number of bins (that may be less than the total range of amplitude values (e.g., 0-255), but large enough to be statistically significant).

Processor 140 may receive the color information and the spatial information from image analyzer 130 and the user and/or platform information from policy module 120. Based on the received information, an algorithm resident in processor 140 may determine how much to adjust the brightness of backlight 190 (via backlight controller 180) and how much to adjust the color amplitudes of display data at panel 160 (via image adjuster 150).

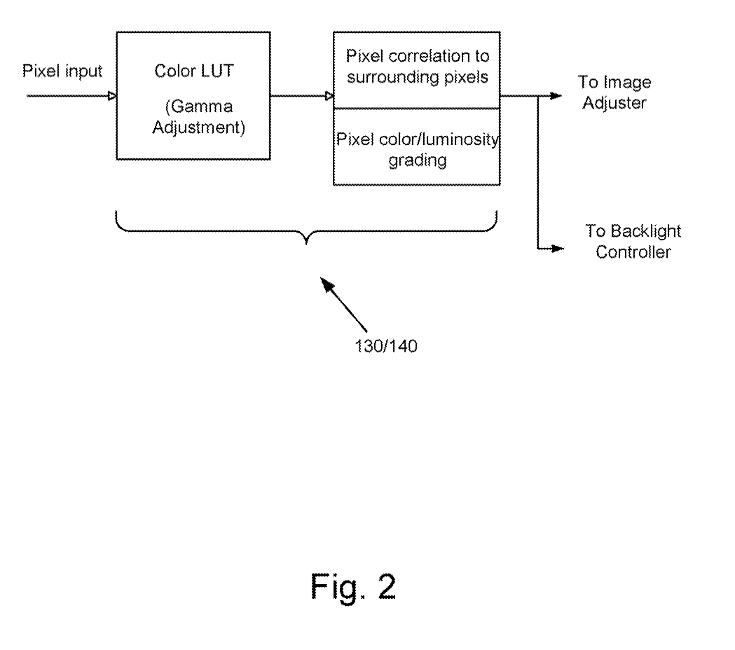

As will be explained further herein, processor 140 may adjust backlight 190 and the display data more “aggressively” (e.g., greater backlight dimming and color enhancement for greater power savings) or less aggressively (e.g., less backlight dimming and color enhancement for somewhat lower power savings) based on the spatial information from image analyzer 130. In either ease, the algorithm performed by processor 140 may aim to achieve a similar user-perceived image quality for both cases of 1) relatively diffuse spatial information across the image and 2) relatively concentrated spatial information across the image. These concepts will be further explained with regard to the exemplar) functionality in FIG. 2.

FIG. 2 conceptually illustrates the functionality of analyzer 130 and processor 140, although the functionality therein may be implemented via other combinations of hardware and/or software than that specifically shown in FIG. 1. In some implementations, prior to analyzing the input pixels, analyzer 130 and/or processor 140 may apply a gamma adjustment via a color lookup table (LUT), although this need not occur in all implementations.

Next analyzer 130 may collect information on pixel luminosity/color (and/or another function of a pixel's color values) as it scans the pixels of an image. Such color information may, in some implementations, be binned by analyzer 130 over a number of like color values in a histogram-like manner. Analyzer 130 may also calculate the degree to which pixels of similar color/luminosity are distributed spatially within the image (as may, for example, be determined via an autocorrelation function). In some implementations, (e.g., where a similar number of bins are used for each) such spatial information may be a second dimension in a histogram or other structure generated from the color information.

Processor 140 may consider the spatial autocorrelation (or other measure of spatial spreading) of display pixels sharing similar luminance/color values, to assist with the identification of cases where backlight 190 may be dimmed, while overall image luminance/color is enhanced with minimal impact to the perceived quality of the resulting displayed image. For example, when pixels of corresponding or similar color values are evenly distributed throughout the image or frame, an overall dimming of the backlight 190 may have a less significant impact on the perceived quality of the display than in cases where pixels of the corresponding or similar color values are localized in particular areas of the image. Such localization or bunching may occur, for example, when there are particular regions of low contrast within the image but where the details are important.

The ability of analyzer 130 to build a histogram (or other data structure) of display data that captures not only the relative luminance/colors of the image pixels, but also the spatial distribution of like-valued pixels, allows for better decision-making within algorithms of processor 140. Processor 140, based on such spatial information, may adjust backlight 190 for power savings (or other usability benefits) while also adjusting pixel luminance/color in panel 160 to counterbalance the backlight adjustments and preserve perceived image quality. This additional information about, for example, the spatial autocorrelation of like-valued pixels may aid in determining where subtle differences in color value may be more important (e.g., subtle shadings within a bright object in an otherwise dark background) versus less important (e.g., subtle differences in color that are more or less evenly distributed across an image).

Incorporation of this additional, spatial information into a backlight adjustment (and compensation) algorithm can determine how aggressive processor 140 should be for a given image, when a goal (in addition to power savings) is to reduce the loss of important color/brightness information. Thus, a higher power saving may be achieved by processor 140 and backlight controller 180/image adjuster 150 for an image that has a small correlation factor (more generally, lower spatial relatedness) without jeopardizing perceived image quality. Similarly a lower aggressiveness may be employed by processor 140 and backlight controller 180/image adjuster 150 to preserve image quality for an image with a high correlation factor (more generally, higher spatial relatedness).

Returning to FIG. 1, image adjuster 150 may adjust the color values for pixels and/or sub-pixels from frame buffer 110 according to control information from processor 140. In some implementations, adjuster 150 may increase or multiply display data by an inverse amount or percentage so that the backlight 190 is decreased. In some implementations, adjuster 150 may adjust to a lesser extent those pixels approaching the limits of the range of possible color values; this is done to avoid or reduce clipping (e.g., a phenomenon which occurs when an adjusted signal is limited by the full range of color values). In some implementations, image adjuster 150 may adjust data in a LUT, rather than making per-pixel or per-value adjustments. In some implementations, adjuster 150 may adjust only certain ranges of color values, but not other ranges, according to known color adjustment algorithms. In any event, however, image adjuster 150 may adjust at least some pixels to a greater or lesser extent based on spatial information sent to processor 140 from image analyzer 130.

Display panel 160 may include an LCD panel or any other type of flat-panel display suitable for use with a backlight 190. In one embodiment, the pixels of panel 160 may be formed using thin film transistor (TFT) technology, and each pixel is composed of three sub-pixels that, when enabled, cause a red, green, and blue (RGB) color to be displayed, respectively. Each sub-pixel may be controlled by a TFT that enables light from a display backlight to pass through the sub-pixel, thereby illuminating the sub-pixel to a particular color. Each sub-pixel color may vary according to a color value representing the sub-pixel. Sub-pixel coloring is known in the art and any appropriate technique for providing sub-pixel coloring can be used.

Backlight hot key(s) 170, if present, may permit a user to manually increase or decrease the brightness of backlight 190. The output of hot keys 170 may be combined with the output of processor 140 by a combiner to generate a combined input signal to backlight controller 180. Hot keys 170, if present, may permit the user of system 100 to adjust the backlight 190 according to personal preference, and possibly in the presence or absence of an ambient light sensor (e.g., that adjusts, for example, backlight 190 based on the amount of ambient light around the system 100). Such hot keys 170 may permit a user to override, to a certain extent, the backlight setting (and thus power usage) and image quality determined by policy module 120 and processor 140.

Backlight controller 180 may use a combined value from processor 140 and/or hot keys 170 to control the brightness of backlight 190. In one embodiment, controller 180 may include, or be coupled with, an inverter that directly controls backlight 190. In general, controller 180 may modify a duty cycle of a pulse-width modulated (PWM) signal to control the brightness of backlight 190. There may also be other methods of backlight control, such as writing to a register (not shown) on the display. This register may be accessed via I2C or some other register interface. This modulation or control (which if decreased (or increased, depending on polarity) results in more backlight dimming and power savings) may be accomplished in various known modes based on the combined control signal from at least processor 140 (and possibly hot keys 170).

Backlight 190 may include a small florescent tube, array of light emitting diodes (LEDs), a single LED, etc. In general, the less backlight 190 is modulated by controller 180, the brighter its emitted light and the more power it uses. Conversely, the more backlight 190 is modulated by controller 180, the dimmer its emitted light becomes and the less power it uses. The brightness of backlight 190 may be adjusted in conjunction with color values sent to display 160 to maintain perceived image brightness. The degree of such adjustment of backlight 190 and of the display data via adjuster 150 may be determined based on the spatial information (e.g. autocorrelation, although the claimed invention is not limited thereto) of like-colored pixels in the image as determined by analyzer 130 and/or processor 140.

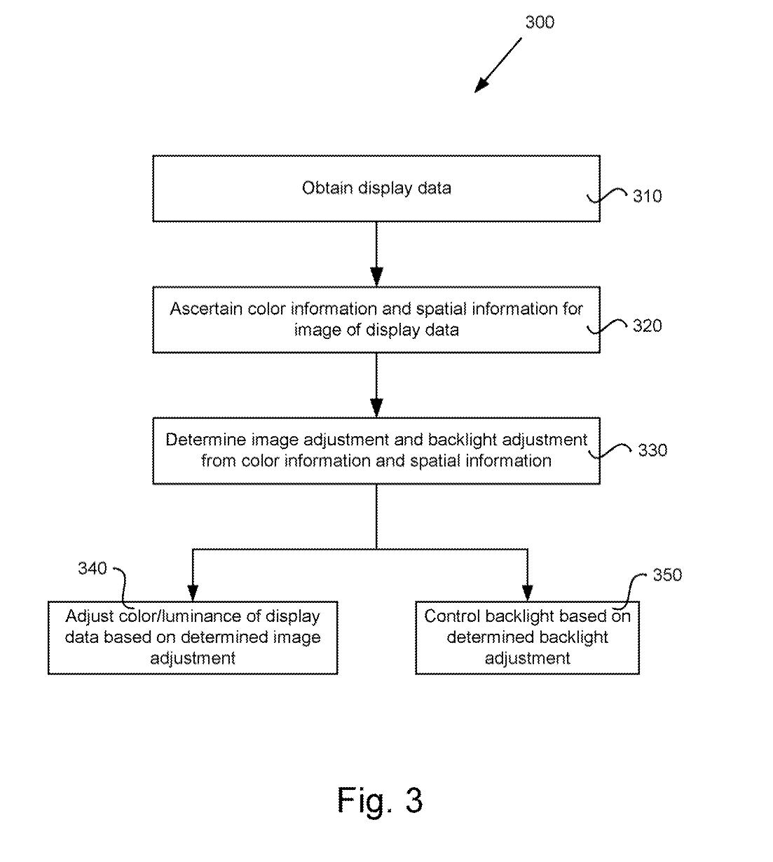

FIG. 3 illustrates a method 300 of controlling image brightness and a backlight for a flat-panel display. Although described with respect to FIGS. 1 and/or 2 for ease of explanation, the scheme described in FIG. 3 should not be construed as limited to the particulars of these other figures.

The method may begin with analyzer 130 obtaining display data from buffer 110 [act 310]. Display data may be read in any convenient order, format, etc. that facilitates the image-based analysis by analyzer 130. Act 310 may also include performing any pre-adjustment, such as gamma correction using a LUT on the display data from buffer 110. Then the following color and spatial analysis by analyzer 130 may be performed on the gamma-corrected (or otherwise-pre-adjusted) display data.

Processing may continue with analyzer 130 determining color information and spatial information for an image of display data [act 320]. In some implementations, the color information may be a histogram of color amplitude or brightness across all pixels in the image (or perhaps the brightest sub-pixel within all pixels). Although a histogram of color values may be used, any other suitable function of color/luminosity values in an image may also be used. Act 320 may also compute spatial information (e.g., autocorrelation or a similar spatial relatedness measure) for similar color levels (e.g., amplitudes or brightnesses). This latter act may determine the degree to which pixels of similar color/luminosity are distributed spatially within the image (e.g., via an autocorrelation function or other suitable spatially relating function).

Processor 140 may calculate the degree, greater or lesser, of image adjustment and backlight adjustment from the color information and spatial information determined by analyzer 130 in act 320 [act 330] In general, the image adjustment may brighten at least some pixels in the image of display data to compensate for a dimmed (to save power) backlight. An algorithm in processor 140, possibly embodied in software or firmware, may use the additional spatial information to make better choices (e.g., in terms of lower visually perceived effects) about the aggressiveness with which it enhances image brightness and adjust the backlight. When an image has luminosity/color that is fairly widely distributed spatially, the adjustments by processor 140 to image data and backlight 190 may be made more aggressively (e.g., for greater power savings) without adversely impacting the visual information conveyed by pixel luminosity/color. Conversely, when an image has localized areas of shared luminosity/color, such adjustments can be made by processor 140 more conservatively, to preserve the visually perceived contrast between different areas of the image.

Method 300 may continue with image adjuster 150 adjusting the color/luminance values of display data based on the image adjustment that was determined by processor 140 in act 330 [act 340]. Depending on the decision in act 330 (which in turn is based on the spatial information), act 340 may brighten the display data to a relatively greater degree when the spatial information is relatively random or uniform or dispersed across an image. Act 340 may brighten the display data to a relatively lesser degree to preserve visual contrast when the spatial information is relatively spatially concentrated or bunched or grouped in the image. Act 340 may selectively modify the brightness of some pixels but not others, or of some pixels differently than others, depending on an initial brightness of the pixels (e.g., their bin, or range, within a histogram of possible brightnesses).

Method 300 may continue with backlight controller 180 controlling the backlight 190 based on the backlight adjustment that was determined by processor 140 in act 330 [act 350]. Depending on the decision in act 330 (which in turn is based on the spatial information), act 350 may dim the backlight 190 (e.g., by modulation) to a greater degree when the spatial information is relatively random or uniform or dispersed across the image. Act 350 may dim the backlight 190 to a relatively lesser degree to preserve visual contrast when the spatial information is relatively spatially concentrated or bunched or grouped in the image.

Acts 340 and 350 may be performed at substantially the same time to display the adjusted color information on panel 160 in conjunction with the modulation of backlight 190.

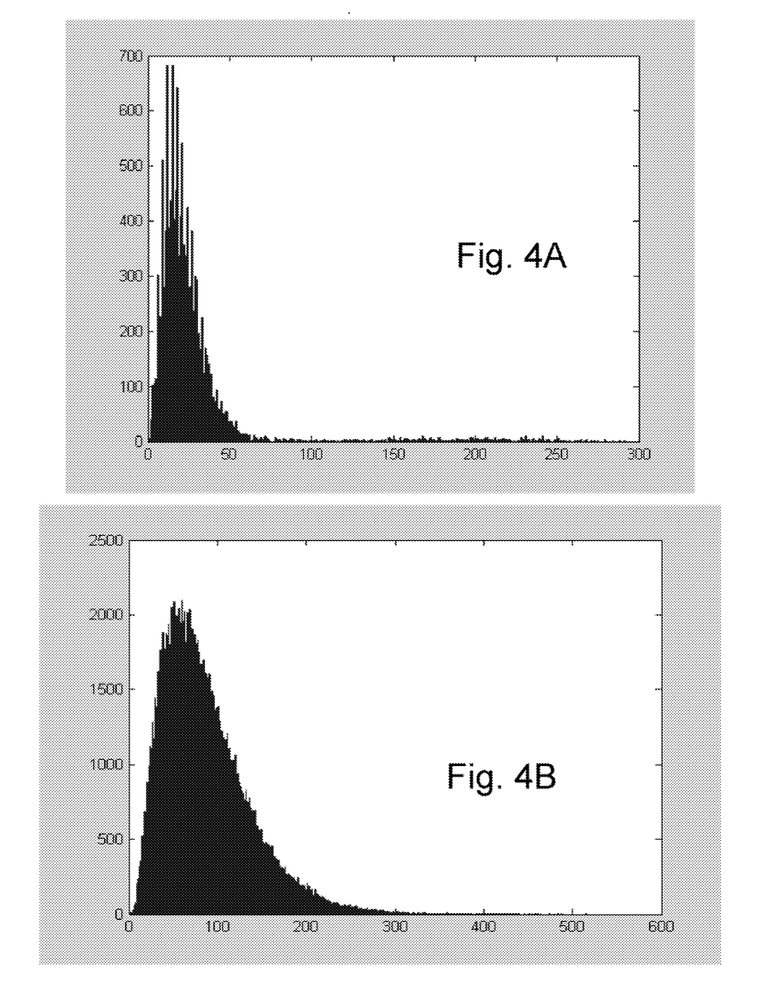

FIGS. 4A and 4B respectively illustrate correlation functions for two different images. The particular correlation function used may be a difference function over, for example, a 3×3 or 5×5 pixel neighborhood, although other correlation functions are possible. In FIGS. 4A and 4B, a low value on the horizontal “X” axis indicates higher spatial correlation and a high value indicates lower spatial correlation. The vertical “Y” axis indicates the number of pixels with a particular correlation value. From looking at the figures, it may be apparent that a greater percentage of the pixels in FIG. 4A have a higher spatial correlation than those in FIG. 4B. This result indicates that, all else being equal, backlight dimming and image brightening may be applied more aggressively to the image corresponding to the correlation function in FIG. 4B than to the image corresponding to the correlation function in FIG. 4A.

The above-described scheme and/or system may advantageously use pixel spatial information (e.g., autocorrelation) to improve the decision on how to adjust backlight 190 and pixel values sent to panel display 160. By contrast, conventional schemes of dynamic, content-dependent backlight modulation may be based on pixel-value histograms only, and thus do not provide such additional freedom for power-performance optimization.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although the scheme described herein has been illustrated as being performed after the frame buffer 110, it may also be performed by other portions of mobile system 100, such as a graphics processing unit (GPU), central processing unit (CPU), dedicated logic or software elsewhere in the video/graphics pipeline, etc. In other words, it is both possible and contemplated for the spatial information-based adjustments to be determined earlier (or later possibly) in the display pipeline than specifically described.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method of adjusting the display of data on a flat panel display comprising:
ascertaining color value information and spatial distribution information for pixels in an image;
determining a desired image adjustment and a desired backlight adjustment based on both the color value information and spatial distribution information;
adjusting color values of at least some pixels in the image based on the desired image adjustment; and
controlling a backlight intensity based on the desired backlight adjustment.

2. The method of claim 1 wherein the adjusting color values of at least some pixels approximately offsets a visual effect of the controlling a backlight intensity.

3. The method of claim 1 wherein the ascertaining color value information includes:
counting numbers of pixels falling within a number of discrete color value ranges.

4. The method of claim 1 wherein the ascertaining spatial distribution information includes:
performing an autocorrelation calculation for pixels in the image.

5. The method of claim 1 wherein the determining includes:
determining a relatively large image adjustment and a relatively large backlight adjustment when the spatial distribution information indicates that, a color in the image is relatively diffuse throughout the image.

6. The method of claim 1 wherein the determining includes:
determining a relatively small image adjustment and a relatively small backlight adjustment when the spatial distribution information indicates that a color in the image is relatively concentrated within the image.

7. The method of claim 1 wherein the adjusting color values of at least some pixels includes:
increasing color values to visually brighten at least, some pixels.

8. The method of claim 1 wherein the controlling a backlight intensity includes:
decreasing the backlight intensity.

9. An mobile system comprising:
a panel display to visually present display information;
an image adjuster to adjust the display information prior to receipt by the panel display;
a backlight proximate the panel display to provide illumination thereto;
a. backlight controller coupled to the backlight to control an intensity of the illumination;
an image analyzer to produce color prevalence information and spatial distribution information about an image of the display information; and
a processor to control the image adjuster and the backlight controller based on the color prevalence information and the spatial distribution information from the image analyzer.

10. The system of claim 9 wherein the image adjuster adjusts image brightness for one or more portions of the display information to be displayed on the panel display in accordance with how diffuse the spatial distribution information provided to the processor is.

11. The system of claim 9 wherein the backlight controller controls the intensity of the illumination from the backlight in accordance with how diffuse the spatial distribution information provided to the processor is.

12. The system of claim 9 wherein the image analyzer is arranged to produce the spatial distribution information by performing a correlation operation on the image.

13. The system of claim 9 wherein the image analyzer is arranged to produce the prevalence information by binning color values in the image.

14. A method of adjusting the display of data on a flat panel display, comprising:
determining spatial information indicating how color information is spatially distributed throughout an image of display data; and
modifying a color brightness of one or more portions of an image to be displayed on the flat panel display based on the spatial information.

15. The method of claim 14 further comprising:
modifying an intensity of a backlight proximate to the flat panel display based on the modified spatial information.

16. The method of claim 15 wherein the modification to the intensity of the backlight approximately visually counterbalances the modification to the color brightness.

17. The method of claim 15 wherein modifying the intensity of the backlight includes:
modifying a pulse width modulation signal that controls backlight illumination.

18. The method of claim 15 further comprising:
determining color brightness information of the image of display data; and
calculating how to modify the color brightness of the one or more portions of the image and how to modify the intensity of the backlight based on both the color brightness information and the spatial information.

19. The method of claim 18, wherein the calculating modifies the color brightness and the intensity of the backlight to a greater extent when the spatial information indicates that the color information is more widely spatially distributed throughout the image of display data.

20. The method of claim 18, wherein the calculating modifies the color brightness and the intensity of the backlight to a lesser extent when the spatial information indicates that the color information is more closely spatially concentrated within the image of display data.
